(19) United States
(12) Patent Application Publication
(10) Pub. No.: US 2025/0132621 A1
(43) Pub. Date: Apr. 24, 2025

(54) METHOD OF FORMING A MULTI-COMPONENT ROTATING ASSEMBLY AND ROTATING ASSEMBLY

(71) Applicant: Schaeffler Technologies AG & Co. KG, Herzogenaurach (DE)

(72) Inventors: Trent Hendershot, Wooster, OH (US); Long Souers, North Canton, OH (US)

(73) Assignee: Schaeffler Technologies AG & Co. KG, Herzogenaurach (DE)

(21) Appl. No.: 18/439,946

(22) Filed: Feb. 13, 2024

Related U.S. Application Data
(60) Provisional application No. 63/591,774, filed on Oct. 20, 2023.

(51) Int. Cl. H02K 1/28; H02K 7/08; H02K 15/02

(52) U.S. Cl. CPC H02K 1/28; H02K 7/08; H02K 15/02; H02K 2213/03

(57) ABSTRACT

A rotating assembly having a first rotating part having a first body with a radially extending outer rim portion and a second rotating part having a receiving area defined by a radially extending inner flange with an inwardly extending shoulder defined thereon. A plurality of anti-rotation encapsulation recesses located in the first body at least one of at or adjacent to the radially extending outer rim portion. Staking elements of the second rotating part formed via application of an axial load that extend into respective ones of the plurality of anti-rotation encapsulation recesses such that the staking elements enable the transmission of torque between the first and second rotating parts. An assembly method is also provided.

### CROSS-REFERENCE TO RELATED APPLICATIONS

This application claims the benefit of U.S. Provisional Application No. 63/591,774, filed Oct. 20, 2023, which is incorporated herein by reference as if fully set forth.

### TECHNICAL FIELD

The present disclosure is directed to a method of forming a multi-component rotating assembly from two or more components, such as a rotor carrier and a bearing carrier of an electric motor, that is adapted to carry or transmit a torque or load, and to such a rotating assembly.

### BACKGROUND

Multi-component rotating assemblies formed of two or more components are generally known. Some assemblies may consist of two carrier plates that are connected together in a torque transmitting manner. Assembling the carrier plates together can be accomplished by various means, such as separate fasteners, an interference fit, or welding.

These known techniques for achieving the connection between carrier plates have certain drawbacks. For example, interference fits require precise dimensional control, and can result in radial deformation and high stresses in sensitive areas of a rotating or spinning assembly. Separate fasteners, such as rivets or bolts, require additional assembly steps as well as drilling or otherwise forming aligned holes for the fasteners. Welding can result in deformation of parts as well as localized areas of the parts having the material properties that are negatively affected. Additionally for rotating assemblies, each of these methods involves different requirements for further balancing of the rotating assembly as well as alignment between the parts.

Accordingly, it would be desirable to provide an improved method of forming a rotating assembly.

### SUMMARY

A method of forming rotating assembly, the method includes a) providing a first rotating part and a second rotating part, the first rotating part having a first body with a radially extending outer rim portion, and the second rotating part having a receiving area defined by a radially extending inner flange with an inwardly extending shoulder defined thereon, b) forming a plurality of anti-rotation encapsulation recesses in the first body at least one of at or adjacent to the radially extending outer rim portion, c) placing the first rotating part into the second rotating part with the radially extending outer rim portion of the first rotating part adjacent to the radially extending inner flange of the second rotating part, with a portion of the first rotating body being axially supported by the inwardly extending shoulder, and d) staking respective portions of the second rotating part into respective ones of the plurality of anti-rotation encapsulation recesses via application of an axial load to form staking elements such that the staking elements enable the transmission of torque between the first and second rotating parts.

The first rotating part can be placed into the second rotating part with the radially extending outer rim portion of the first rotating part adjacent to the radially extending inner flange of the second rotating part with a clearance fit or a location fit.

In another aspect, a rotating assembly, which may be part of an electric motor for an electric or hybrid-electric vehicle drivetrain, is provided and includes a first rotating part, which can be formed of cast metal, having a first body with a radially extending outer rim portion, a second rotating part, which can be formed as stamped or deep-drawn thin walled metal, having a receiving area defined by a radially extending inner flange with an inwardly extending shoulder defined thereon, and a plurality of anti-rotation encapsulation recesses located in the first body at least one of at or adjacent to the radially extending outer rim portion. The first rotating part is located in the second rotating part with the radially extending outer rim portion of the first rotating part adjacent to the radially extending inner flange of the second rotating part, and a portion of the first rotating body is axially supported by the inwardly extending shoulder. Staking elements of the second rotating part that are formed via the application of an axial load extend into respective ones of the plurality of anti-rotation encapsulation recesses such that the staking elements enable the transmission of torque between the first and second rotating parts.

The first rotating part can be located in the second rotating part with a clearance fit or a locational fit.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a partial perspective view, in cross-section, with the X, Y and axial direction (coinciding with the rotation axis A) indicated, showing a rotating assembly being assembled from first and second rotating parts, prior to these parts being fixed together.

FIG. 1A is an enlarged detail of a first embodiment of an anti-rotation encapsulation recess in the first rotating part.

FIG. 1B is an enlarged detail of a second embodiment of an anti-rotation encapsulation recess in the first rotating part.

FIG. 2 is an enlarged cross-sectional view, partially broken away so that the rotation axis A is shown, showing the interface between the first and second rotating parts of FIG. 1.

FIG. 3 is a top view after staking elements are formed by application of an axial force, with the staking element that is shown extending from the second rotating part into an anti-rotation encapsulation recess in the first rotating part.

FIG. 4 is an enlarged cross-sectional view through the staking element and the anti-rotation encapsulation recess in FIG. 3.

FIG. 5 is an enlarged view showing the shape of the staking element, with the first rotating part removed for clarity.

FIG. 6 is a view of a portion of the staking element of FIG. 5 showing the reduced stress concentrations.

FIG. 7 is a view of an electric motor having the rotating assembly as disclosed herein.

FIG. 8 is a flow chart illustrating one method of forming the rotating assembly using staking.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terms “about” and “generally” mean within 10% of a specified value. The terminology includes the words specifically noted above, derivatives thereof and words of similar import.

A “thin-walled” stamped or drawn metal part as used herein generally has a wall thickness in the range of 0.2 mm-5.0 mm.

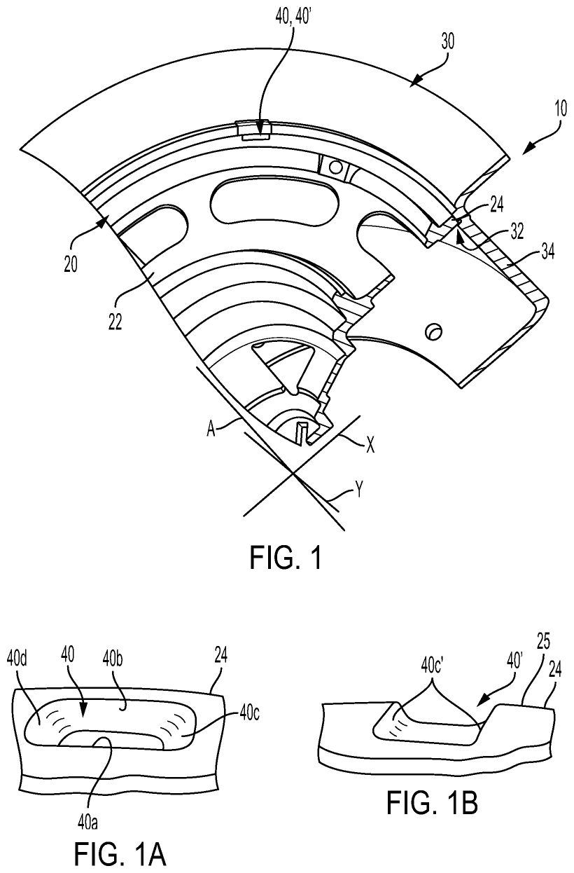

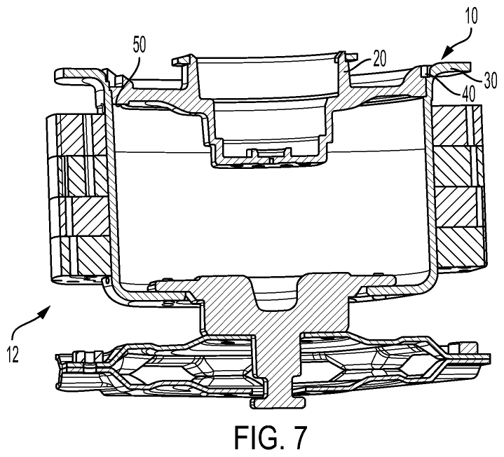

Referring now to FIGS. 1-4, an embodiment of a rotating assembly 10 is shown, which is adapted to rotate about a rotation axis A, shown in FIG. 1. The rotating assembly 10 includes a first rotating part 20 having a first body 22 with a radially extending outer rim 24 and a second rotating part 30 having a receiving area 32 defined by the radially extending inner flange 34 that also includes an inwardly extending shoulder 36 defined thereon. The first rotating part 20 may be a cast or machined part formed of metal, such as aluminum. The second rotating part 30 can be a thin-walled stamped or deep drawn sheet metal part, for example formed of steel or a steel alloy, with the radially extending inner flange 34 having a thickness that is 5 mm or less. In one application, the first rotating part 20 and the second rotating part 30 are respectively a bearing carrier and a rotor carrier for an electric motor 12, shown in FIG. 7, for example for use in electric vehicles. However, the rotating assembly 10 can be used for joining first and second rotating parts 20, 30 used in any type of rotating assembly in which the more heavily constructed first part which is for example cast or machined metal, is joined to a second part that is thin walled.

In order to join the first rotating part 20 with the second rotating part 30 in a torque-transmitting manner, a plurality of anti-rotation encapsulation recesses 40 are located in the first body 22 of the first rotating part 20 that at least one of at or adjacent to the radially extending outer rim portion 24. In the illustrated embodiment, there are a plurality of the anti-rotation encapsulation recesses 40 that are equally spaced apart in a radial direction. For example, there may be eight anti-rotation encapsulation recesses 40 that are spaced apart by 45° in a circumferential direction. However, the specific number of the anti-rotation encapsulation recesses 40 can be varied depending on the torque to be transmitted, but is at least two. Further, the anti-rotation encapsulation recesses 40 may be pocket-shaped, as shown in detail in FIG. 1A, having radially inner and outer sides 40a, 40b as well as end surfaces 40c in the circumferential direction that are adapted to receive a torque load. Alternatively, the anti-rotation encapsulation recesses 40′, as shown in FIG. 1B, may be formed as teeth or notches that extend through the radially extending outer rim portion 24 that also have end surfaces 40c′ in the circumferential direction that are adapted to receive a torque load. The anti-rotation encapsulation recesses 40, 40′ may be cast, machined, or formed by stamping in the first rotating part 20.

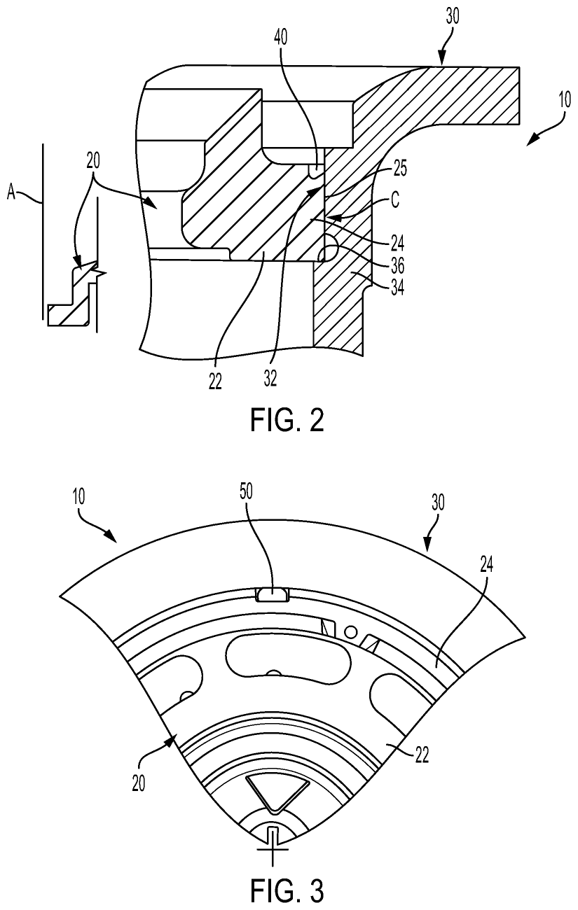

As shown in detail in FIG. 2, the first rotating part 20 is located in the second rotating part 30 with the radially extending outer rim portion 24 of the first rotating part 20 adjacent to the radially extending inner flange 34 of the second rotating part 30 with a clearance fit C, which can be for example 0.5 mm or less, or a locational fit, which provides zero clearance. A portion 26 of the first rotating part 20 is axially supported by the inwardly extending shoulder 36.

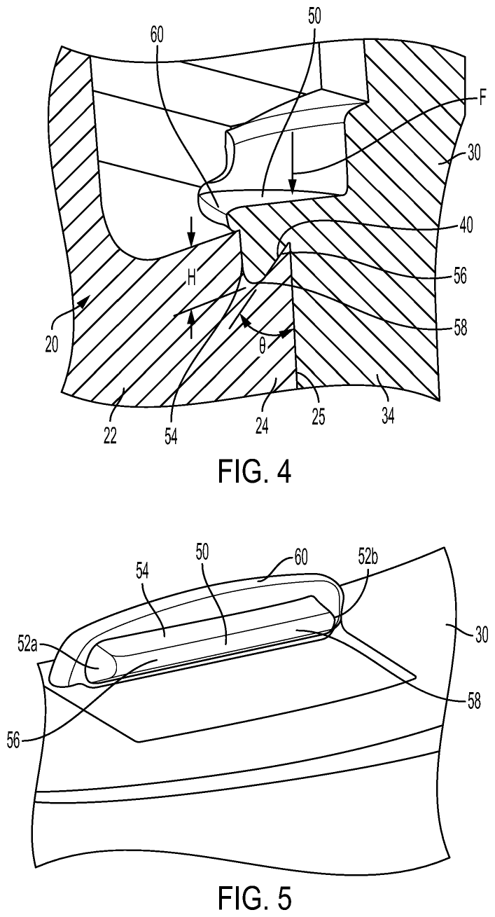

Referring now to FIGS. 3 and 4, staking elements 50 of the second rotating part 30 are formed via application of an axial force F, represented schematically in FIG. 4, and extend into respective ones of, and in the illustrated embodiment, each of the plurality of anti-rotation encapsulation recesses 40 such that the staking elements 50 enable the transmission of torque between the first and second rotating parts 20, 30. In one embodiment, the staking elements 50 are formed by a stamp that is directed axially as well as radially inwardly in order to allow the material of the second rotating art 30 to be displaced into each of the plurality of anti-rotation encapsulation recesses 40.

As shown in detail in FIGS. 3-5, in the illustrated embodiment the anti-rotation encapsulation recesses 40 are completely filled by the respective staking elements 50.

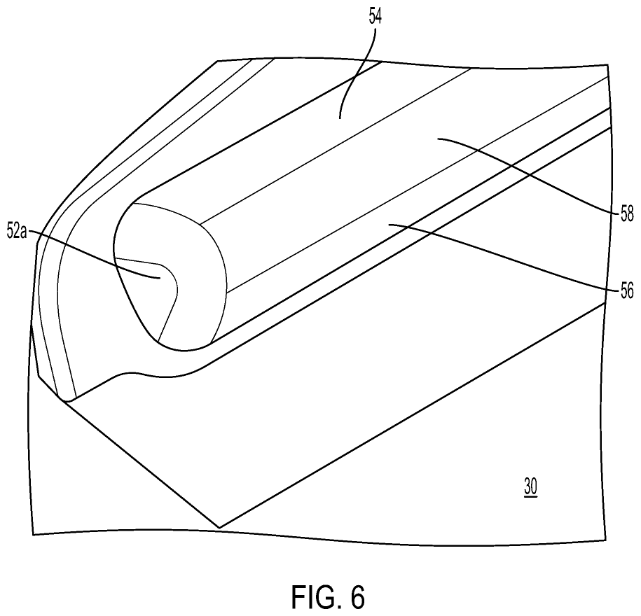

As shown in FIGS. 5 and 6, where the first rotating part 20 has been removed for clarity, the staking elements 50 has an axially extending portion with two end faces 52a, 52b in the circumferential direction as well as a radially inner face 54 and a radially outer face 56. The end 58 of the staking element 50 formed at the intersection of the radially inner face 54 and radial outer face 56 is rounded as indicated at 58.

In one arrangement, the radially inner face 54 extends generally parallel to the axis A of the rotating assembly 10. Further, the radially outer face 56 extends at an angle θ with respect to the axis A which is for example between 3° and 60°, as indicated in FIG. 4. The length of the staking elements 50 can vary, but may be in the range of 5 mm to 20 mm.

Further, the staking elements 50 each include a radially extending portion 60 that extends over at least a portion of an axial end surface of the radially extending outer rim portion 24 of the first rotating part 20. This holds the first rotating part 20 axially in position in the second rotating part 30 with the radially extending outer rim portion 24 clamped between the inwardly extending shoulder 36 and the radially extending portions 60 of the staking elements 50.

As shown in FIG. 1B, the anti-rotation encapsulation recesses 40′ may extend radially inwardly from a radially outer surface 25 of the radially extending outer rim 24. However, as shown in FIG. 1A, it is also possible for the anti-rotation encapsulation recesses 40 to be spaced inwardly from the radially outer surface 25.

As shown in FIG. 4, the application of the axial force F to form the staking elements 50 presses the first rotating part 20 against the inwardly extending shoulder 36 of the second rotating part 30.

FIG. 4 also shows an axial height H of each of the staking elements 50. This can be in the range of 1.0 mm-3.0 mm, but the size can vary depending on the particular application. The size of the anti-rotation encapsulation recesses 40 will determine the amount of torque that can be carried between the first rotating part 20 and the second rotating part 30, along with the number of anti-rotation encapsulation recesses 40.

This arrangement of the rotating assembly 10 can be used for example in an electric motor 12 as shown in FIG. 7.

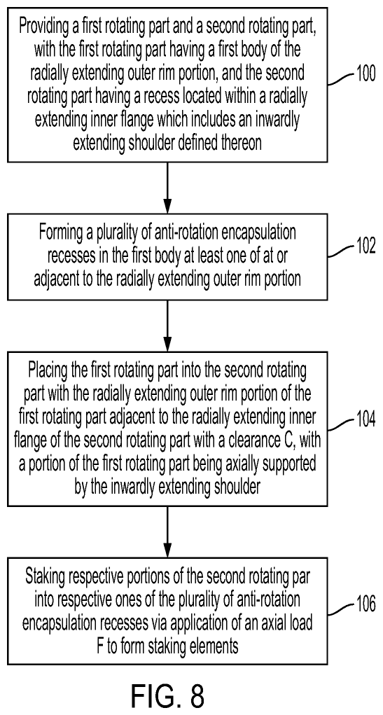

Referring now to FIG. 8, a method of forming the rotating assembly 10 is illustrated in flow chart form. As indicated at 100, the method includes providing a first rotating part 20 and a second rotating part 30, with the first rotating part 20 having a first body 22 of the radially extending outer rim portion 24, and the second rotating part 30 having a receiving area 32 located within a radially extending inner flange 34 which includes an inwardly extending shoulder 36 defined thereon.

As indicated at 102, the method further includes forming a plurality of anti-rotation encapsulation recesses 40 in the first body 22 at least one of at or adjacent to the radially extending outer rim portion 24. As indicated at 104, the method further includes placing the first rotating part 20 into the second rotating part 30 with the radially extending outer rim portion 24 of the first rotating part 20 adjacent to the radially extending inner flange 34 of the second rotating part 30, with a portion 26 of the first rotating part 20 being axially supported by the inwardly extending shoulder 36. As indicated at 106, the method further includes staking respective portions of the second rotating part 30 into respective ones of the plurality of anti-rotation encapsulation recesses 40 via application of an axial load F to form staking elements 50 such that the staking elements 50 enable the transmission of torque between the first and second rotating parts 20, 30.

The method may further include the components of the rotating assembly 10 including one or more of the features described above.

Using this method, the rotating assembly 10 can be assembled without the precise tolerances required for an interference fit as well as avoiding any resulting radial deformation in sensitive areas of a thin-walled part in a rotating or spinning assembly. Further, fasteners such as rivets or bolts as well as welding can be avoided. By adjusting the number and size of the anti-rotation encapsulation recesses 40 and staking elements 50, the amount of torque that can be transmitted is also adjusted based on a particular application.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

What is claimed is:

1. A method of forming rotating assembly, the method comprising:
providing a first rotating part and a second rotating part, the first rotating part having a first body with a radially extending outer rim portion, and the second rotating part having a receiving area defined by a radially extending inner flange with an inwardly extending shoulder defined thereon;
forming a plurality of anti-rotation encapsulation recesses in the first body at least one of at or adjacent to the radially extending outer rim portion;
placing the first rotating part into the second rotating part with the radially extending outer rim portion of the first rotating part adjacent to the radially extending inner flange of the second rotating part, with a portion of the first rotating part being axially supported by the inwardly extending shoulder; and
staking respective portions of the second rotating part into respective ones of the plurality of anti-rotation encapsulation recesses via application of an axial load to form staking elements such that the staking elements enable the transmission of torque between the first and second rotating parts.

2. The method according to claim 1, wherein the second rotating part is formed of stamped sheet metal and the radially extending inner flange has a thickness of less than 5 mm.

3. The method according to claim 1, wherein the anti-rotation encapsulation recesses are completely filled by the respective staking elements.

4. The method according to claim 1, wherein the anti-rotation encapsulation recesses are equally spaced in a circumferential direction.

5. The method according to claim 1, wherein the anti-rotation encapsulation recesses extend radially inwardly from a radially outer surface of the radially extending outer rim portion.

6. The method according to claim 1, wherein the first rotating part is a bearing carrier, and the second rotating part is a rotor carrier for an electric motor.

7. The method according to claim 1, wherein the application of the axial force to form the staking elements presses the first rotating part against the inwardly extending shoulder of the second rotating part.

8. The method according to claim 1, wherein an axial height of each of the staking elements is 1.0 mm-3.0 mm.

9. The method according to claim 1, wherein the staking elements each include an axially extending portion that extends into the anti-rotation encapsulation recesses and a radially extending portion that extends over at least a portion of an axial end surface of the radially extending outer rim portion of the first rotating part.

10. A rotating assembly, comprising:
a first rotating part having a first body with a radially extending outer rim portion;
a second rotating part having a receiving area defined by a radially extending inner flange with an inwardly extending shoulder defined thereon;
a plurality of anti-rotation encapsulation recesses located in the first body at least one of at or adjacent to the radially extending outer rim portion;
the first rotating part being located in the second rotating part with the radially extending outer rim portion of the first rotating part adjacent to the radially extending inner flange of the second rotating part, and a portion of the first rotating part being axially supported by the inwardly extending shoulder; and
staking elements of the second rotating part formed via application of an axial load that extend into respective ones of the plurality of anti-rotation encapsulation recesses such that the staking elements enable the transmission of torque between the first and second rotating parts.

11. The assembly of claim 10, wherein the second rotating part is formed of stamped sheet metal and the radially extending inner flange has a thickness of less than 15 mm.

12. The assembly of claim 10, wherein the anti-rotation encapsulation recesses are completely filled by the respective staking elements.

13. The assembly of claim 10, wherein the anti-rotation encapsulation recesses are equally spaced in a circumferential direction.

14. The assembly of claim 10, wherein the anti-rotation encapsulation recesses extend radially inwardly from a radially outer surface of the radially extending outer rim portion.

15. The assembly of claim 10, wherein the first rotating part is a bearing carrier, and the second rotating part is a rotor carrier for an electric motor.

16. The assembly of claim 10, wherein the application of the axial load to form the staking elements presses the first rotating part against the inwardly extending shoulder of the second rotating part.

17. The assembly of claim 10, wherein an axial height of each of the staking elements is 1.0 mm-3.0 mm.
